(19) United States
(12) Patent Application Publication
(10) Pub. No.: US 2010/0021665 A1
(43) Pub. Date: Jan. 28, 2010

(54) VULCANIZED BIOFUEL HOSE

(76) Inventor: Kenneth Scott Jackson, Lexington, TN (US)

Correspondence Address: MARSHALL & MELHORN, LLC, FOUR SEAGATE - EIGHTH FLOOR, TOLEDO, OH, 43604, US

(21) Appl. No.: 12/179,189

(22) Filed: Jul. 24, 2008

(51) Int. Cl. B32B 1/08; F16L 11/06

(52) U.S. Cl. 428/36.91; 138/137

(57) ABSTRACT

A biofuel hose that resists degradation when exposed to biofuels such as ethanol, an ethanol-hydrocarbon blend, and biodiesel, etc. for prolonged periods of time. The hose has an inner tubular member formed from a vulcanizable, hydrogenated, α, β-unsaturated nitrile-C₄-C₆ conjugated diene copolymer rubber or a blend of a vulcanizable, hydrogenated, α, β-unsaturated nitrile-C₄-C₆ conjugated diene copolymer rubber with a compatible polymer; a backing member around the inner tubular member wherein the backing member is formed from a vulcanizable, a, 1-unsaturated nitrile-C₄-C₆ conjugated diene copolymer rubber or a blend of a vulcanizable, α, β-unsaturated nitrile-C₄-C₆ conjugated diene copolymer rubber with a compatible polymer; and an ozone-resistant protective cover forming an outer surface of the biofuel hose. Preferably, the multilayer, biofuel-compatible hose includes a reinforcement member disposed between the backing layer and the ozone-resistant protective cover.

### BACKGROUND OF THE INVENTION

1. Field of the Invention

The present invention relates to vulcanized hoses and, particularly, to vulcanized automotive fuel hoses for use in biofuel-powered engines.

2. Technical Background and Related Art

Traditionally, hoses are formed from a polymeric material and are employed to transport various fluid mediums from one point to another point. Typically, hoses are used in commercial and household applications such as garden hoses, pneumatic hoses, refrigeration hoses, propane gas hoses, water line hoses; and in the automotive industry as fuel hoses, oil hoses such as brake hoses and power transmission hoses; coolant hoses such as transmission cooler hoses, oil cooler hoses, heater hoses, air conditioner hoses; etc. Hoses used in the automotive industry are specifically designed and constructed from polymeric materials to provide certain desired characteristics. For example, automotive hoses must have sufficient flexibility in order to meet spatial requirements of the specific locale in which the hoses are employed. Furthermore, the various hoses must be designed and constructed to possess properties that allow them to be effective for their particular application over long periods of time. For example, automotive fuel hoses for use in conventional fuel engines must be flexible and exhibit properties that not only provide compatibility with the fuel being transported through the hoses, but they also must have a high degree of impermeability with respect to such fuel.

Nitrile-butadiene rubber (NBR) and hydrogenated nitrile-butadiene rubber (HNBR) are well known materials for use in the manufacture of automotive coolant hoses and conventional-fuel hoses as well as diesel fuel hoses. Diesel engines, for example, are known to use a nitrile-butadiene rubber (NBR) hose to transport diesel fuel. However, the use of NBR hoses in a biodiesel fuel environment presents several problems that make NBR an inadequate barrier material for biodiesel fuels. Biodiesel, in any percentage, with regular diesel fuel develops acidity over time due to the make up of biodiesel which starts out as triglycerides and fatty acids. Small amounts of water which commonly accumulate in biodiesel make a very aggressive environment that is destructive to NBR. The use of biofuels in automobiles requires hoses that have a higher resistance to the biofuels than provided by current automotive hoses.

U.S. Pat. No. 5,795,635 to Iwasaki teaches a combination of HNBR and NBR in a power steering hose construction. A power transmission hose having a vulcanized NBR inner layer exhibits good resistance to compression set, but poor copper ion resistance while a power steering oil hose having a vulcanized HNBR inner layer exhibits good copper ion resistance, but poor resistance to compression set. A composite power steering hose structure composed of HNBR/NBR is poor in both copper ion resistance and compression set.

U.S. Pat. No. 5,830,941 to Aimura, et al. discloses a refrigeration hose composed of HNBR and an ultrafine magnesium silicate powder. The hose exhibits resistance to the permeation of specified gases such as hydrofluorocarbon, hydrochlorofluorocarbon and chlorofluorocarbon gases (such specified gases are referred to generically as “flon” gases by Aimura et al. in the specification).

U.S. Pat. No. 6,536,478 to Kertesz teaches a functionalized, vulcanized multilayer fuel hose for transporting conventional automotive fuel.

U.S. Pat. No. 7,262,244 to Guerin teaches a hose composed of HNBR.

U.S. Pat. Appln. Publication No. 2006/0263556 to Beck, disclose the use of HNBR as a coolant hose.

U.S. Pat. Appln. Publication No. 2007/0227609 to Kurimoto, et al discloses a conventional-fuel hose composed of blend of PVC and HNBR having magnesium Oxide incorporated therein.

Because of rising fuel costs and the growing concerns about the effect of automotive emissions on global warming, the automotive industry is faced with ever increasing pressure from not only Governmental mandates requiring reduced automotive emissions caused by conventional hydrocarbon fuels, but also from consumer advocates demanding alternative fuels to such hydrocarbon fuels in order to reduce America's dependency on foreign oil. Consequently, the automotive industry is faced with designing and constructing fuel hoses that are compatible with such alternative fuels such as biofuels. The use of biofuels in automobiles requires hoses that have a higher resistance to the biofuels than provided by current automotive hoses. Because of the many applications for hoses confronting the automotive industry and the various requirements for such hoses, it is virtually impossible to predict how a hose of a certain construction will perform in any particular application. Accordingly, it has become increasingly more difficult for hose manufacturers to choose the right material or combination of materials to be used in the construction of hoses for any particular application.

In view of the foregoing, it is an object of the present invention to provide a fuel hose for use in an automotive vehicle engine powered by a biofuel such as ethanol, ethanol-hydrocarbon blend or biodiesel.

### SUMMARY OF THE INVENTION

It has now been found that certain multilayer fuel hoses strategically formed from a specific combination of polymeric materials are superior with respect to biofuel compatibility when compared to conventional fuel hoses.

In accordance with a first embodiment of the invention, the biofuel hoses comprise: (1) an inner tubular member formed from a first matrix material selected from the group consisting of a vulcanizable, hydrogenated, α, β-ethylenically unsaturated nitrile-C₄-C₆ conjugated diene copolymer rubber, and a blend of a vulcanizable, hydrogenated, α, β-ethylenically unsaturated nitrile-C₄-C₆ conjugated diene copolymer rubber with certain other polymer(s) that are compatible with the vulcanizable, hydrogenated, α, β-ethylenically unsaturated nitrile-C₄-C₆ conjugated diene copolymer rubber; (2) a backing member or mechanical strengthening layer formed from a second matrix material selected from the group consisting of a vulcanizable α, β-ethylenically unsaturated nitrile-C₄-C₆ conjugated diene copolymer rubber, and a blend of a vulcanizable, α, β-ethylenically unsaturated nitrile-C₄-C₆ conjugated diene copolymer rubber with certain other polymer(s) that are compatible with the vulcanizable, α, β-ethylenically unsaturated nitrile-C₄-C₆ conjugated diene copolymer rubber; and (3) an ozone-resistant protective cover matrix material formed from one of a Styrene-butadiene rubber (SBR), butadiene-nitrile rubber (NBR), chlorinated polyethylene, (CPE), chlorosulfonated polyethylene (CSM), vinylidene-acrylic rubber, acrylic rubber, epichlorohydrin rubber, ethylene-carbon monoxide copolymers (ECO), polychloroprene rubber, polyvinyl chloride (PVC), ethylene-propylene copolymers, ethylene-propylene-diene terpolymers, ultra high molecular weight polyethylene, high density polyethylene, ethylene-acrylic, polyacrylic, and the like, and blends thereof.

In accordance with a second embodiment of the invention, the multilayer biofuel hose of the invention includes a reinforcement member disposed between the backing member and the ozone-resistant cover.

The biofuel-compatible hose of the present invention exhibits superior biofuel-compatibility properties when exposed to biofuels for prolonged periods of time, while maintaining good balance of physical properties such as flexibility, tensile and elongation, and oil resistance, when compared to conventional fuel hoses under similar conditions.

### BRIEF DESCRIPTION OF THE DRAWINGS

FIG. 1 is a perspective view of a biofuel-compatible hose according to a first embodiment of the invention; and

FIG. 2 is a perspective view of a high pressure-resistant, biofuel-compatible hose according to a second embodiment of the invention.

### DETAILED DESCRIPTION OF THE INVENTION

In a first embodiment, the biofuel hose of the invention comprises:
an inner tubular member having an inner circumferential surface providing a pathway for conveying biofuels, and an outer circumferential surface, wherein the inner tubular member is formed from a vulcanizable hydrogenated α, β-ethylenically unsaturated nitrile-C₄-C₆ conjugated diene copolymer rubber or a blend of a vulcanizable hydrogenated α, β-ethylenically unsaturated nitrile-C₄-C₆ conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, nitrile-butadiene rubber (NBR), and the like;
a backing material around the inner tubular member wherein the backing material is formed from chlorinated polyethylene (CPE), chlorosulfonated polyethylene (CSM), vulcanizable α, β-ethylenically unsaturated nitrile-C₄-C₆ conjugated diene copolymer rubber or a blend of a vulcanizable α, β-ethylenically unsaturated nitrile-C₄-C₆ conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, hydrogenated nitrile-butadiene rubber (HNBR), and the like; etc.; and
an ozone-resistant member providing a protective outer cover for the fuel-compatible hose, wherein the ozone-resistant member is formed from a third matrix material selected from the group consisting of Styrene-butadiene rubber (SBR), butadiene-nitrile rubber (NBR), chlorinated polyethylene, (CPE), chlorosulfonated polyethylene (CSM), vinylidene-acrylic rubber, acrylic rubber, epichlorohydrin rubber, ethylene-carbon monoxide copolymers (ECO), polychloroprene rubber, polyvinyl chloride (PVC), ethylene-propylene copolymers, ethylene-propylene-diene terpolymers, ultra high molecular weight polyethylene, high density polyethylene, ethylene-acrylic, polyacrylic, and the like, and blends thereof.

In a second embodiment, the biofuel hose of the invention comprises:
an inner tubular member having an inner circumferential surface providing a pathway for conveying biofuels, and an outer circumferential surface, wherein the inner tubular member is formed from a vulcanizable, hydrogenated α, β-ethylenically unsaturated nitrile-C₄-C₆ conjugated diene copolymer rubber or a blend of a vulcanizable hydrogenated α, β-ethylenically unsaturated nitrile-C₄-C₆ conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, nitrile-butadiene rubber (NBR), and the like;
a backing material around the inner tubular member wherein the backing material is formed from chlorinated polyethylene (CPE), chlorosulfonated polyethylene (CSM), vulcanizable α, β-ethylenically unsaturated nitrile-C₄-C₆ conjugated diene copolymer rubber or a blend of a vulcanizable α, β-ethylenically unsaturated nitrile-C₄-C₆ conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, hydrogenated nitrile-butadiene rubber (HNBR), and the like; etc.;
a reinforcement member formed of any suitable reinforcement material that provides increased pressure and thermal resistance to the biofuel hose and may include organic or inorganic fibers or metal wires such as brass-plated steel wires; and
an ozone-resistant protective cover surrounding the reinforcement member, wherein the ozone-resistant member is selected from the group consisting of Styrene-butadiene rubber (SBR), butadiene-nitrile rubber (NBR), chlorinated polyethylene, (CPE), chlorosulfonated polyethylene (CSM), vinylidene-acrylic rubber, acrylic rubber, epichlorohydrin rubber, ethylene-carbon monoxide copolymers (ECO), polychloroprene rubber, polyvinyl chloride (PVC), ethylene-propylene copolymers, ethylene-propylene-diene terpolymers, ultra high molecular weight polyethylene, high density polyethylene, ethylene-acrylic, polyacrylic, and the like, and blends thereof.

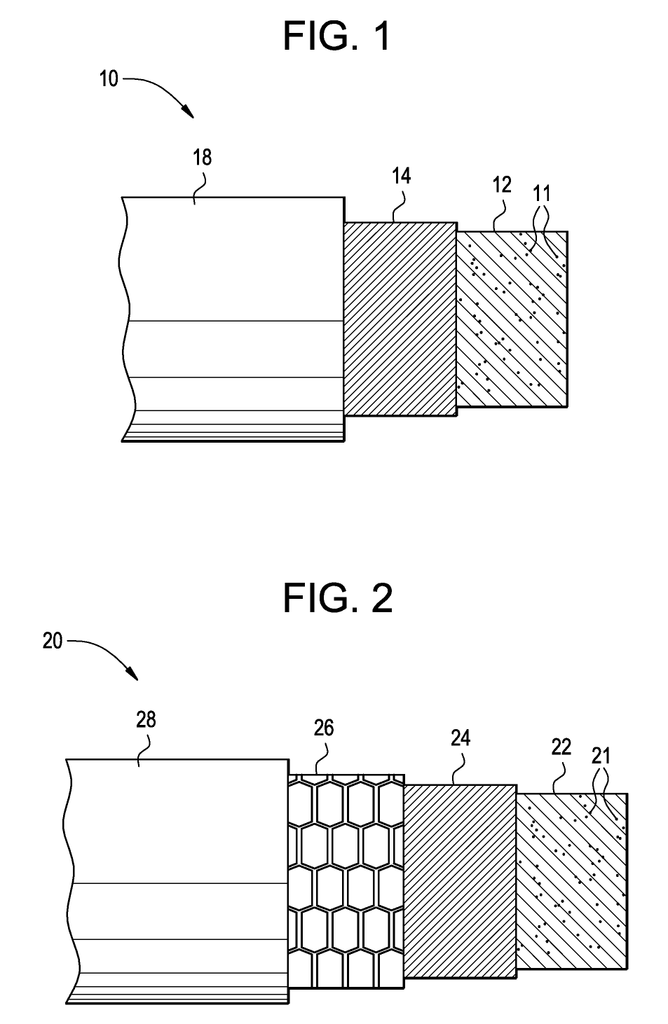

Referring to the Figures, FIG. 1 illustrates a multilayer biofuel-compatible hose 10 having an inner tubular member 12 including a plurality of additives 11 dispersed therein, a backing layer 14 surrounding the inner tubular member 11 and a cover 18 surrounding the backing layer 14. FIG. 2 Illustrates another embodiment of the invention wherein a multilayer, biofuel-compatible hose 20 consists of an inner tubular member 22, a backing layer 24 surrounding the inner tubular member 22, a reinforcement member 26 surrounding the backing layer 24 and a protective cover 28 surrounding the reinforcement layer 26. Typically, the plurality of additives 11 and 21 illustrated in FIGS. 1 and 2, respectively consists of one or more additives dispersed in one or more of the polymeric layers of the multilayer, biofuel hose. Preferably, the one or more additives are present in at least the inner tubular member.

The α, β-unsaturated nitrile of the vulcanizable, hydrogenated α, β-ethylenically unsaturated nitrile-C₄-C₆ conjugated diene rubber of the invention is one of acrylonitrile, methacrylonitrile, ethanacrylonitrile, and the like; and the C₄-C₆ conjugated diene is one of butadiene, 2,3-dimethyl butadiene, isoprene, 1,3-pentene, 2-methyl, 1,3-butadiene, and the like and mixtures thereof. In a preferred aspect of the invention, the vulcanizable, hydrogenated α, β-ethylenically unsaturated nitrile-C₄-C₆ conjugated diene rubber is a vulcanizable, hydrogenated acrylonitrile-butadiene copolymer rubber (NBR).

The α, β-unsaturated nitrile of the vulcanizable α, β-ethylenically unsaturated nitrile-C₄-C₆ conjugated diene rubber of the invention is one of acrylonitrile, methacrylonitrile, ethanacrylonitrile, and the like; and the C₄-C₆ conjugated diene is one of butadiene, 2,3-dimethyl butadiene, isoprene, 1,3-pentene, 2-methyl, 1,3-butadiene, and the like and mixtures thereof. In a preferred aspect of the invention, the vulcanizable α, β-ethylenically unsaturated nitrile-C₄-C₆ conjugated diene rubber is a vulcanizable, acrylonitrile-butadiene copolymer rubber (NBR).

One or more of the inner tubular member, the backing member and the ozone-resistant, protective cover may contain additional ingredients or additives in their respective matrices that serve to either promote or enhance desired or required characteristics such as good balance of physical properties, e.g., flexibility, tensile and elongation, durability and oil resistance. Such ingredients or additives include fillers, plasticizers, coagents, peroxides, metal oxides and/or hydroxides, processing aids, antioxidants, etc. Preferably, the ingredients or additives are added to at least the inner tubular member. While the kinds and amounts of additives used in the various layers of the biofuel hose are not particularly critical, the following provides an overall view of the most desirable kinds and amounts of additives found to be useful in the invention.

Suitable fillers found to be effective in the present invention include carbon black, graphite, silicon dioxide, silica, diatomaceous earth, magnesium carbonate, calcium carbonate, magnesium silicate, aluminum silicate, mica, talc, titanium dioxide, aluminum sulfate, calcium sulfate, wollastinite, molybdenum disulfate, clay and combinations thereof. Typically, the filler(s) is added in amounts ranging from about 10 to 60% by weight of the appropriate matrix material. Preferably, the filler(s) is a carbon black. Typically, carbon blacks employed include N110, N330, N332, N472, N550, N630, N642, N650, N762, N770, N907, N908, N990, and N991. Preferably, the filler is carbon black N990;

Suitable plasticizers found to be effective in the present invention include hydrocarbons, glycols, aldehydes, ethers, esters, ether-esters and combinations thereof. Typically, the desired plasticizer(s) is added to the α, β-ethylenically unsaturated nitrile-C₄-C₆ conjugated diene rubber inner tubular member in amounts ranging from about 5 to 15% by weight of the appropriate matrix material. Preferably, the plasticizer(s) is Trioctyl Tri Mellitate (TOTM) which typically is added in amounts ranging from about 5 to 15% by weight of the hydrogenated α, β-ethylenically unsaturated nitrile-C₄-C₆ conjugated diene rubber or blend of hydrogenated α, β-ethylenically unsaturated nitrile-C₄-C₆ conjugated diene rubber with a compatible polymer.

Suitable coagents found to be effective in the present invention include maleimides, triallyl cyanurate, triallyl isocyanurate, diallyl terephthalate, 1,2-vinyl polybutadiene, di- and tri functional methacrylates and diacrylates and metal ion versions of these coagents, and combinations thereof. Preferably, the coagents are present in amounts ranging from about 1 to 5% by weight of the appropriate matrix material.

Suitable peroxides include 2,5-dimethyl-2,5-di(t-butylperoxy)hexyne-3; 2,5-dimethyl-2,5-di(t-butylperoxy)hexane; dicumyl peroxide; di-t-butyl peroxide; 1,1-bis(t-butylperoxy)-3,3,5trimethylcyclohexane; 2,4dichlorobenzoyl peroxide; benzoyl peroxide; p-chlorobenzoyl peroxide; 4,4-bis(t-butyl peroxy)valerate; t-butylcumyl peroxide; di-t-amyl peroxide; t-butyl hydroperoxide; alpha-bis-(t-butylperoxy)-p-diisopropylbenzene and combinations thereof. Preferably, the peroxides are present in amounts ranging from about 2 to 6% by weight of the appropriate matrix matrial.

Suitable metal oxide and/or hydroxides include zinc oxide, zinc hydroxide, magnesium oxide, magnesium hydroxide, calcium oxide, calcium hydroxide, aluminum hydroxide and combinations thereof. Preferably, the metal oxides and/or hydroxides are present in amounts ranging from about 0 to 8% by weight of the appropriate matrix material.

Suitable processing aids include zinc oxide, zinc hydroxide, magnesium oxide, magnesium hydroxide, calcium oxide, calcium hydroxide, aluminum hydroxide and combinations thereof. Preferably, the processing aids are present in amounts ranging from about 0 to 8% by weight of the appropriate matrix material.

Suitable antioxidants include phenols, hydrocinnamates, hydroquinones, hydroquinolines, diphenylamines, mercaptobenzimideazoles and combinations thereof. Preferably, the antioxidants are present in amounts ranging from about 0 to 3% by weight of the appropriate matrix material.

Other conventional additives in conventional amounts may be used provided that they do not adversely affect the desirable properties of the multiplayer, biofuel-compatible hose of the present invention.

In accordance with the present invention, the inner tubular member is a vulcanizable, hydrogenated, α, β-nitrile-C₄-C₆ conjugated diene rubber or a blend of a hydrogenated α, β-nitrile-C₄-C₆ conjugated diene rubber with a compatible polymer such as a vulcanizable hydrogenated α, β-ethylenically unsaturated nitrile-C₄-C₆ conjugated diene copolymer rubber or a blend of a vulcanizable hydrogenated α, β-ethylenically unsaturated nitrile-C₄-C₆ conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, nitrile-butadiene rubber (NBR), and the like. Preferably, the inner tubular member is a hydrogenated nitrile-butadiene rubber such as hydrogenated acrylonitrile-butadiene rubber. The vulcanizable hydrogenated nitrile-diene copolymer rubber or a blend of a vulcanizable hydrogenated nitrile-diene copolymer rubber with a compatible polymer, has a much higher bond saturation than nitrile-butadiene rubber. The vulcanizable hydrogenated nitrile-diene copolymer rubber typically exhibits a bond saturation of about 91 to 100%. It has been found that the higher bond saturation of hydrogenated nitrile-diene copolymer rubber greatly decreases the susceptibility of attack by the biodiesel fuel and contaminates. Typically, the inner layer of a vulcanizable hydrogenated nitrile-diene copolymer rubber or blend of a vulcanizable hydrogenated nitrile-diene copolymer rubber with a compatible polymer material of the present invention has a wall thickness of between about 0.005 to 0.100 inches, and preferably, between about 0.020 to 0.050 inches.

The backing layer or mechanical strengthening layer of the biofuel-compatible hose of the present invention is formed from chlorinated polyethylene (CPE), chlorosulfonated polyethylene (CSM), vulcanizable α, β-nitrile-C4-C6 conjugated diene copolymer rubber or a blend of a vulcanizable α, β-nitrile-C4-C6 conjugated diene copolymer rubber with a compatible polymer such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, hydrogenated nitrile-butadiene rubber (HNBR), and the like; etc. Preferably, the backing layer is a hydrogenated nitrile-butadiene copolymer rubber such as hydrogenated acrylonitrile-butadiene copolymer rubber. The backing layer not only provides mechanical strength to the composite hose structure but also aids in the extrusion of the hose by allowing the hose wall to be thicker so that it is easier to support itself through the extrusion process. Typically, the wall thickness of the backing or mechanical strengthening layer is between about 0.035 to 0.125 inches, and preferably, between about 0.045 to 0.085 inches. As an additional benefit, the backing layer or mechanical strengthening layer makes the hose cost effective.

The reinforcement member is formed of any suitable reinforcement material that provides increased pressure and thermal resistance to the biofuel hose and may include organic or inorganic fibers or metal wires such as brass-plated steel wires. Typically, the reinforcement layer is a single layer of reinforcement material. The reinforcement material is preferably an organic fiber material, such as nylon, polyester, aramid, cotton or rayon. The reinforcement member may be constructed of any suitable type such as braid, spiral, knit or wrapped. The reinforcement member provides the biofuel-compatible hose with increased pressure resistance.

The outer protective cover surrounding the reinforcement member can be any elastomeric or thermoplastic vulcanizate material that effectively protects the biofuel-compatible hose from ozone degradation and other environmental hazards. Typically, the ozone-resistant outer protective cover is formed from styrene-butadiene rubber (SBR), butadiene-nitrile rubber (NBR), chlorinated polyethylene, (CPE), chlorosulfonated polyethylene (CSM), vinylidene-acrylic rubber, acrylic rubber, epichlorohydrin rubber, ethylene-carbon monoxide copolymers (ECO), polychloroprene rubber, polyvinyl chloride (PVC), ethylene-propylene copolymers, ethylene-propylene-diene terpolymers, ultra high molecular weight polyethylene, high density polyethylene, ethylene-acrylic, polyacrylic, and the like, and blends thereof.

The amounts expressing quantities, percentages, parts, etc. of the components and additives making up the various layers of the biofuel hose of the invention are to be understood as being modified by the term “about”. Furthermore, all ranges of the amounts of components include combination of the minimum and maximum amounts disclosed and include any intermediate ranges therein.

The various polymeric materials used in forming the inner tubular layer, the backing layer and the protective cover layer of the biofuel hoses of the invention are vulcanizable polymeric materials. The biofuel-compatible hoses of the invention are cured using one or more suitable curing or vulcanization agents. Preferably, the curing or vulcanization is conducted on a mandrel using conventional methods and temperatures. Typically, the layers are extruded simultaneously or sequentially onto a mandrel wherein vulcanization is conducted at a temperature of about 150° to 170° C. for a period of about 30 to 60 minutes.

The use of an adhesive to secure the various layers to one another is not critical; however, it may be desirable in certain constructions to use an adhesive between one or more layers, particularly, between the backing layer and the reinforcement member and between the reinforcement member and the protective outer cover. Where an adhesive is used, any of the conventional adhesives commonly used in the art can be employed.

As indicated earlier in the specification, each of the materials forming the various layers, i.e. the inner tubular member, the backing member and the ozone-resistant outer protective cover used in constructing the biofuel hose of the present invention, may contain one or more ingredients or additives to provide improved characteristics to the biofuel hose.

The following is a typical formulation used for forming the inner tubular member in the present invention; however, similar formulations may be used with the appropriate matrix material for forming the backing layer and/or the ozone-resistant cover:

| Component | PHR |
|---|---|
| Hydrogenated acrylonitrile-butadiene rubber (Matrix) | 100 |
| Carbon black, N990 | 85 |
| Trioctyl tri mellitate (TOTM) | 10 |
| Elastomag 170 | 3 |
| Naugard 445 | 1.5 |
| Vanox MTI | 1 |
| Vulcup 40KE | 7.5 |
| Total | 207.5 |

While this formulation is typical for the inner tubular member, other additives and amounts of such additives as well as other appropriate matrix materials may be used in forming the various members such as the inner tubular member, the backing member, the reinforcing member and the ozone-resistant cover.

Where percentages are used to designate the amount of ingredients used in the formulations of the present invention, the percentages of ingredient are based upon the matrix containing the ingredients.

The multilayer, biofuel-compatible hose of the present invention is useful to connect the fuel tank to the fuel filler pipe in automotive vehicles that are powered by biofuels such as ethanol, ethanol-hydrocarbon blends and biodiesel. The reinforced, multilayer, biofuel-compatible hose is particularly useful for fuel lines operating under increased pressure such as fuel feed lines and fuel return lines.

What is claimed is:

1. A vulcanized biofuel hose comprising:
an inner tubular member having an inner circumferential surface providing a pathway for conveying biofuels, and an outer circumferential surface, wherein said inner tubular member is formed from a vulcanizable, hydrogenated α, β-unsaturated nitrile-C₄-C₆ conjugated diene copolymer rubber or a blend of a vulcanizable hydrogenated α, β-ethylenically unsaturated nitrile-C₄-C₆ conjugated diene copolymer rubber with one or more compatible polymers selected from the group consisting of such as polyvinyl chloride (PVC), chlorinated polyethylene (CPE), chlorosulfonated polyethylene (CSM), epichlorohydrin, ethylene-acrylic, polyacrylic, ethylene-vinyl acetate copolymers, and α, β-ethylenically unsaturated nitrile-C₄-C₆ conjugated diene copolymer rubber (NBR);
a backing member around said inner tubular member wherein said backing member is formed from a vulcanizable material selected from the group consisting of chlorinated polyethylene, chlorosulfonated polyethylene, α, β-unsaturated nitrile-C₄-C₆ conjugated diene copolymer rubber or a blend of a vulcanizable, α, β-unsaturated nitrile-C₄-C₆ conjugated diene copolymer rubber with one or more compatible polymers selected from the group consisting of polyvinyl chloride, chlorinated polyethylene, chlorosulfonated polyethylene, epichlorihydrin, ethylene acrylic, polyacrylic, and ethylene-vinyl acetate copolymers; and
an ozone-resistant protective cover forming an outer surface of said biofuel hose, wherein said ozone-resistant protective cover is formed from a polymeric material selected from the group consisting of Styrene-butadiene rubber (SBR), butadiene-nitrile rubber (NBR), chlorinated polyethylene, (CPE), chlorosulfonated polyethylene (CSM), vinylidene-acrylic rubber, acrylic rubber, epichlorohydrin rubber, ethylene-carbon monoxide copolymers (ECO), polychloroprene rubber, polyvinyl chloride (PVC), ethylene-propylene copolymers, ethylene-propylene-diene terpolymers, ultra high molecular weight polyethylene, high density polyethylene, ethylene-acrylic, polyacrylic, and blends of an α, β-unsaturated nitrile-C₄-C₆ conjugated diene copolymer rubber with polyvinyl chloride.

2. The biofuel hose of claim 1 further comprising a reinforcement member disposed between said backing material and said ozone-resistant protective cover, wherein said reinforcement member is formed from natural or synthetic fibers selected from the group consisting of cotton, polyester, nylon, rayon and aramid; or metal wire.

3. The biofuel hose of claim 1 wherein said inner tubular member is formed from a vulcanizable, hydrogenated α, β-unsaturated nitrile-C₄-C₆ conjugated diene copolymer rubber.

4. The biofuel hose of claim 3, wherein said vulcanizable, α, β-unsaturated nitrile-C₄-C₆ conjugated diene copolymer rubber is a vulcanizable, acrylonitrile-butadiene rubber.

5. The biofuel hose of claim 1 wherein said inner tubular member is formed from a blend of vulcanizable, hydrogenated α, β-unsaturated nitrile-C₄-C₆ conjugated diene copolymer rubber with one or more compatible polymers selected from the group consisting of polyvinyl chloride, chlorinated polyethylene, chlorosulfonated polyethylene, epichlorihydrin, ethylene acrylic, polyacrylic, ethylene vinyl acetate copolymers, α, β-unsaturated nitrile-C₄-C₆ conjugated diene rubbers, and mixtures thereof.

6. The biofuel hose of claim 5 wherein said inner tubular member is formed from a blend of vulcanizable, hydrogenated acrylonitrile-butadiene copolymer rubber with polyvinyl chloride.

7. The biofuel hose of claim 1 wherein said inner tubular member has a thickness of about 0.005 to 0.100 inches and said backing member has a thickness of about 0.035 to 0.125 inches.

8. The biofuel hose of claim 1 wherein said inner tubular member has a thickness of about 0.020 to 0.050 inches and said backing member has a thickness of about 0.045 to 0.085 inches.

9. The biofuel hose of claim 1 wherein said inner tubular member has a bond saturation of about 91% to about 100%.

10. The biofuel hose of claim 1 wherein at least one of said inner tubular member, said backing member and said ozone-resistant cover includes a plurality of additives compounded therein, wherein said plurality of additives includes one or more fillers, plasticizers, coagents peroxides, metal oxides and/or hydroxides, antioxidants and processing aids.

11. The biofuel hose of claim 1 wherein said backing layer is formed from a vulcanizable, α, β-unsaturated nitrile-C₄-C₆ conjugated diene copolymer rubber.

12. The biofuel hose of claim 11 wherein said vulcanizable, α, β-unsaturated nitrile-C₄-C₆ conjugated diene copolymer rubber is vulcanizable acrylonitrile-butadiene rubber.

13. The biofuel hose of claim 1 wherein said backing member is formed from a blend of a vulcanizable α, β-unsaturated nitrile-C₄-C₆ conjugated diene copolymer rubber with a vulcanizable polymer selected from the group consisting of polyvinyl chloride, chlorinated polyethylene, chlorosulfonated polyethylene, epichlorihydrin, ethylene acrylic, polyacrylic, and ethylene vinyl acetate copolymers.

14. The biofuel hose of claim 13 wherein said backing member is formed from a blend of vulcanizable, acrylonitrile-butadiene rubber with polyvinyl chloride.

15. The biofuel hose of claim 1 wherein said ozone-resistant protective cover is formed from ethylene-propylene-diene terpolymer.

16. The biofuel of claim 1 wherein said biofuel hose is one of an automotive biofuel fuel filler hose, a biofuel feed line and a biofuel return line.

17. A vulcanized biofuel hose comprising:
(1) An inner tubular member having an inner circumferential surface providing a pathway for conveying biofuels, and an outer circumferential surface, wherein said inner tubular member consists essentially of:
(a) about 10% to about 60% by weight vulcanizable, hydrogenated acrylonitrile-butadiene rubber;
(b) about 10% to about 60% by weight filler selected from the group consisting of carbon black, graphite, silicon dioxide, silica, diatomaceous earth, magnesium carbonate, calcium carbonate, magnesium silicate, aluminum silicate, mica, talc, titanium dioxide, aluminum sulfate, calcium sulfate, wollastinite, molybdenum disulfate, clay and combinations thereof;
(c) about 5% to about 15% by weight plasticizer selected from the group consisting of hydrocarbons, glycols, aldehydes, ethers, esters, ether-esters and combinations thereof;
(d) about 1% to about 5% by weight coagent selected from the group consisting of maleimides, triallyl cyanurate, triallyl isocyanurate, diallyl terephthalatel, 1,2-vinyl polybutadiene, di- and tri functional methacrylates, diacrylates and combinations thereof;
(e) about 2% to about 6% by weight peroxide selected from the group consisting of 2,5-dimethyl-2,5-di(t-butylperoxy)hexyne-3; 2,5-dimethyl-2,5-di(t-butylperoxy)hexane; dicumyl peroxide; di-t-butyl peroxide; 1,1-bis(t-butylperoxy)-3,3,5trimethylcyclohexane; 2,4dichlorobenzoyl peroxide; benzoyl peroxide; p-chlorobenzoyl peroxide; 4,4-bis(t-butyl peroxy) valerate; t-butylcumyl peroxide; di-t-amyl peroxide; t-butyl hydroperoxide; alpha-bis-(t-butylperoxy)-p-diisopropylbenzene and combinations thereof;
(f) about 0% to about 8% by weight of at least one of a metal oxide and metal hydroxide selected from the group consisting of zinc oxide, zinc hydroxide, magnesium oxide, magnesium hydroxide, calcium oxide, calcium hydroxide, aluminum hydroxide and combinations thereof;
(g) about 0% to about 8% by weight processing aid selected from the group consisting of stearic acid, stearates, polyethylene, amines, oils organic esters and combinations thereof; and
(h) about 0% to about 3% by weight antioxidant selected from the group consisting of phenols, hydrocinnamates, hydroquinones, hydroquinolines, diphenylamines, mercaptobenzimideazoles and combinations thereof:
(2) a backing member around said inner tubular member wherein said backing member is formed from a vulcanizable acrylonitrile-butadiene or a vulcanizable blend of an acrylonitrile-butadiene rubber with a polymer selected from the group consisting of polyvinyl chloride, chlorinated polyethylene, chlorosulfonated polyethylene, epichlorihydrin, ethylene acrylic, polyacrylic, and ethylene vinyl acetate copolymers; and
(3) a protective outer cover for said biofuel hose, said outer cover formed from a vulcanizable ozone-resistant member, wherein said ozone-resistant member is polyvinyl chloride, chlorinated polyethylene, chlorosulfonated polyethylene, epichlorihydrin, ethylene acrylic, polyacrylic, ethylene vinyl acetate copolymers and nitrile-butadiene rubber.

18. The biofuel hose of claim 18 further including a reinforcement member disposed between said backing member and said ozone-resistant cover, said reinforcement member formed from natural or synthetic fibers selected from the group consisting of cotton, polyester, nylon, rayon and aramid; or metal wire.

19. A vulcanized biofuel hose comprising:
(1) An inner tubular member having an inner circumferential surface providing a pathway for conveying biofuels, and an outer circumferential surface, wherein said inner tubular member consists essentially of:
(a) about 10% to about 60% by weight a blend of vulcanizable, hydrogenated α, β-unsaturated nitrile-C₄-C₆ conjugated diene copolymer rubber with one or more compatible polymers selected from the group consisting of polyvinyl chloride, chlorinated polyethylene, chlorosulfonated polyethylene, epichlorihydrin, ethylene acrylic, polyacrylic, ethylene vinyl acetate copolymers, α, β-unsaturated nitrile-C₄-C₆ conjugated diene rubbers, and mixtures thereof;
(b) about 10% to about 60% by weight filler selected from the group consisting of carbon black, graphite, silicon dioxide, silica, diatomaceous earth, magnesium carbonate, calcium carbonate, magnesium silicate, aluminum silicate, mica, talc, titanium dioxide, aluminum sulfate, calcium sulfate, wollastinite, molybdenum disulfate, clay and combinations thereof;
(c) about 5% to about 15% by weight plasticizer selected from the group consisting of hydrocarbons, glycols, aldehydes, ethers, esters, ether-esters and combinations thereof:
(d) about 1% to about 5% by weight coagent selected from the group consisting of maleimides, triallyl cyanurate, triallyl isocyanurate, diallyl terephthalatel, 1,2-vinyl polybutadiene, di- and tri functional methacrylates, diacrylates and combinations thereof;
(e) about 2% to about 6% by weight peroxide selected from the group consisting of 2,5-dimethyl-2,5-di(t-butylperoxy)hexyne-3; 2,5-dimethyl-2,5-di(t-butylperoxy)hexane; dicumyl peroxide; di-t-butyl peroxide; 1,1-bis(t-butylperoxy)-3,3,5trimethylcyclohexane; 2,4dichlorobenzoyl peroxide; benzoyl peroxide; p-chlorobenzoyl peroxide; 4,4-bis(t-butyl peroxy) valerate; t-butylcumyl peroxide; di-t-amyl peroxide; t-butyl hydroperoxide; alpha-bis-(t-butylperoxy)-p-diisopropylbenzene and combinations thereof;
(f) about 0% to about 8% by weight of at least one metal oxide and metal hydroxide selected from the group consisting of zinc oxide, zinc hydroxide, magnesium oxide, magnesium hydroxide, calcium oxide, calcium hydroxide, aluminum hydroxide and combinations thereof;
(g) about 0% to about 8% by weight processing aid selected from the group consisting of stearic acid, stearates, polyethylene, amines, oils organic esters and combinations thereof; and
(h) about 0% to about 3% by weight antioxidant selected from the group consisting of phenols, hydrocinnamates, hydroquinones, hydroquinolines, diphenylamines, mercaptobenzimideazoles and combinations thereof:
(2) a backing member around said inner tubular member wherein said backing is formed from an acrylonitrile-butadiene rubber; and
(3) an ozone-resistant member disposed around said reinforcement member providing a protective outer cover for said hose, wherein said ozone-resistant member is formed from a an ethylene-propylene-diene terpolymer.

20. The biofuel hose of claim 19 further including a reinforcement member disposed between said backing member and said ozone-resistant cover, wherein said reinforcement member is formed from natural or synthetic fibers selected from the group consisting of cotton, polyester, nylon, rayon and aramid; or metal wire.
